(19) United States
(12) Patent Application Publication
(10) Pub. No.: US 2008/0104997 A1
(43) Pub. Date: May 8, 2008

(54) Method and apparatus for dividing brittle material

(76) Inventor: Ryoji Koseki, Ishikawa-Ken (JP)

Correspondence Address: FLYNN THIEL BOUTELL & TANIS, P.C., 2026 RAMBLING ROAD, KALAMAZOO, MI, 49008-1631, US

(21) Appl. No.: 11/975,991

(22) Filed: Oct. 23, 2007

(30) Foreign Application Priority Data
Nov. 2, 2006 (JP) 298907/2006

(51) Int. Cl. C03B 21/02; B23K 26/02; G01N 21/55; G01N 21/892

(52) U.S. Cl. 65/97; 219/121.67; 219/121.81; 356/239.7; 65/174

(57) ABSTRACT

A minute groove M1 is formed from one end 101a of a division-planned line 101 to the other end 101b thereof by use of a cutter 14A by moving a first working head A, and while the groove M is being irradiated with laser beam L, inspection is performed by use of an inspection device 15 to check whether or not a crack has propagated from the groove M1 and division has been performed. Storage means 13A stores the position of an undivided portion on the basis of a detection signal of this inspection device 15.

Thereafter, after the backward movement of the first working head 7A, the undivided portion is again irradiated with laser beam L, with the above-described cutter 14A supported above, whereby the undivided portion is completely divided.

Material glass 2 can be divided exactly according to the division-planned line 101 without forming a groove M double in the division-planned line 101.

### FIELD OF THE INVENTION

The present invention relates to a method and an apparatus for dividing a brittle material and, more particularly, to a dividing method and a dividing apparatus suitable when dividing, for example, glass by forming a minute groove on a surface of the glass and then irradiating the groove with laser beam.

### DESCRIPTION OF THE PRIOR ART

Methods for dividing a glass plate, which is a brittle material, have hitherto been well known. In such conventional dividing methods, first, a minute continuous groove is formed by a mechanical cutter on a surface of the glass along a division-planned line on the glass, a crack is caused to be propagated from the above-described groove by irradiating the groove with CO₂ laser beam to heat the groove, whereby the glass is divided exactly according to the division-planned line.

In the above-described division of glass, as fast division as possible is required. However, if the moving speed of laser beam is too fast, an undivided portion in which the glass is not completely divided may sometimes remain.

Therefore, inspection has hitherto been performed to check whether or not the glass has been completely divided exactly according to a division-planned line and for example, an inspection device described in Patent Document 1 (Japanese Patent Laid-Open No. 10-323778) is proposed as such an inspection device. In the Patent Document 1, a working head is not moved but a brittle material is caused to perform relative movement with respect to the working head on a horizontal plane. An image of a leading end of a crack that occurs in the brittle material is taken with a camera and subjected to image processing, whereby a judgment is made as to whether or not the glass has been divided.

In the above-described conventional working method, in a case where during the dividing work of the glass, an undivided portion in which the glass is not divided has been detected by such an inspection device as described in Patent Document 1, it is necessary to completely divide the undivided portion.

In this case, after a working head that radiates laser beam and a mechanical cutter are moved backward to the above-described undivided portion, a minute groove is formed again along the planned-division line by use of the mechanical cutter and thereafter the minute groove is irradiated with laser beam from the working head to perform division.

However, if a minute groove is again formed in the undivided portion by use of the mechanical cutter like this, there is a possibility that a positional displacement may occur between the minute groove formed last time and the minute groove formed this time. For this reason, uneven areas are formed in these minute grooves and a portion where a double groove is formed occurs. When division is performed by irradiating these portions with laser beam, defective products are formed, thereby posing a problem.

In the above-described inspection device of Patent Document 1, inspection light radiating means is arranged on the top surface side of a brittle material and a camera that takes a worked portion is arranged below the brittle material. For this reason, the inspection device of Patent Document 1 has the problems of a complicated construction and a large size.

### SUMMARY OF THE INVENTION

In view of the above-described circumstances, the first aspect of the present invention is to provide a method for dividing a brittle material, which is such that by use of an apparatus comprising a working head that is moved relatively with respect to a brittle material, a groove forming mechanism that is provided on the working head and forms a minute continuous groove in the brittle material along a division-planned line of the brittle material, a dividing mechanism that is provided on the working head and causes a crack to be propagated from the minute groove by irradiating the brittle material with laser beam while being moved following the groove forming mechanism, an inspection means that is provided on the working head and inspects whether or not the place of the division-planned line has been divided, and storage means that stores the position of an undivided portion detected by the inspection means, the working head is moved from one end of the division-planned line to the other end thereof with respect to the brittle material, whereby a continuous minute groove is formed by the groove forming mechanism along the division-planned line, thereafter division is performed by causing a crack to be propagated from the minute groove by use of the dividing mechanism, a divided portion is detected by the inspection device, and at the same time a divided portion is detected by the inspection device, whereas the position of the undivided portion detected by the inspection means is stored by use of the storage means, and when an undivided portion has been detected, the working head is moved along the undivided portion and the brittle material is divided exactly according to the division-planned line by irradiating the brittle material with laser beam by use of the dividing mechanism without the formation of a groove by the groove forming mechanism.

The second aspect of the present invention is that on the premise of the first aspect above, the inspection means comprises inspection light radiating means that radiates inspection light toward the brittle material and light receiving means that receives reflected light occurring when the inspection light radiated from the inspection light radiating means is reflected by a divided surface of the brittle material, and that the inspection light radiating means and the light receiving means are arranged on a front surface side of the brittle material to be worked to detect an undivided portion.

In the third aspect of the present invention, an apparatus for dividing a brittle material comprising a groove forming mechanism that forms a minute continuous groove in the brittle material along a division-planned line of the brittle material and a dividing mechanism that causes a crack to be propagated from the minute groove by irradiating the brittle material with laser beam while being moved following the groove forming mechanism, further comprises an inspection device that inspects whether or not the place of the division-planned line has been divided. The inspection device comprises inspection light radiating means that radiates inspection light toward the brittle material and light receiving means that receives reflected light occurring when the inspection light radiated from the inspection light radiating means to the brittle material is reflected by a divided surface of the brittle material. The inspection light radiating means and the light receiving means are arranged so as to move relatively parallel to the divided surface on a front surface side of the brittle material.

In the fourth aspect of the present invention, an apparatus for dividing a brittle material comprising a groove forming mechanism that forms a minute continuous groove in the brittle material along a division-planned line of the brittle material and a dividing mechanism that causes a crack to be propagated from the minute groove by irradiating the brittle material with laser beam while being moved following the groove forming mechanism, further comprises an inspection device that inspects whether or not the place of the division-planned line has been divided, the inspection device comprising inspection light radiating means that radiates inspection light toward the brittle material and light receiving means that receives reflected light occurring when the inspection light radiated from the inspection light radiating means to the brittle material is reflected by a rear surface of the interior of the brittle material. The inspection light radiating means and the light receiving means are arranged so as to be able to move relatively parallel to the divided surface on a front surface side of the brittle material. The inspection device judges that a divided surface has been formed when the light receiving means cannot receive reflected light even inspection light is radiated from the inspection light radiating means to the brittle material.

The fifth aspect of the present invention is that on the premise of the third or fourth aspect above, a working head capable of moving relatively with respect to the brittle material is provided with the groove forming mechanism and the dividing mechanism. The apparatus comprises a moving mechanism that moves the working head and a control means that controls the moving mechanism and has a storage means that stores the position of an undivided portion detected by the inspection device. The working head is moved from one end of the division-planned line to the other end thereof with respect to the brittle material, whereby a continuous minute groove is formed along the division-planned line, thereafter division is performed by causing a crack to be propagated from the minute groove by use of the dividing mechanism, a divided portion is detected by the inspection device, whereas the position of the undivided portion detected by the inspection device is stored by use of the storage means. When an undivided portion has been detected by the inspection device, the working head is moved along the undivided portion and the brittle material is divided exactly according to the division-planned line by irradiating the brittle material with laser beam by use of the dividing mechanism without the formation of a groove by the groove forming mechanism.

According to the above-described configuration, after a minute groove has been formed along a division-planned line from one end to the other end thereof, a new minute groove is not formed along the division-planned line, but in this state laser beam is radiated from the dividing mechanism to an undivided portion, whereby the undivided portion is divided. That is, in dividing the undivided portion, a minute groove is not formed double along the division-planned line and, therefore, the undivided portion is divided exactly according to the division-planned line formed last time.

Accordingly, even when an undivided portion occurs in the working of a brittle material, it is possible to divide the brittle material exactly according to the division-planned line. By providing an inspection device in the working head, it is possible to inspect whether or not a brittle material has been actually divided while the brittle material is being divided with good efficiency.

Because inspection light radiating means and light receiving means can be arranged in close proximity to each other as an inspection device for an undivided portion, the configuration of the inspection device is simplified and it is possible to miniaturize the inspection device compared to a conventional configuration.

### BRIEF DESCRIPTION OF THE DRAWINGS

FIG. 1 is a plan view showing an embodiment of the present invention;

FIG. 2 is a partial sectional view of a principal part taken along the II-II line of FIG. 1;

FIG. 3 is a schematic perspective view showing how material glass 2 is worked by a first working head 7A of FIG. 1;

FIG. 4 is a sectional view showing the relationship between an inspection device 15 and the material glass 2 shown in FIG. 3; and

FIG. 5 is a sectional view showing a principal part of an inspection device 15 as the second embodiment of the present invention.

### DETAILED DESCRIPTION OF THE EMBODIMENTS

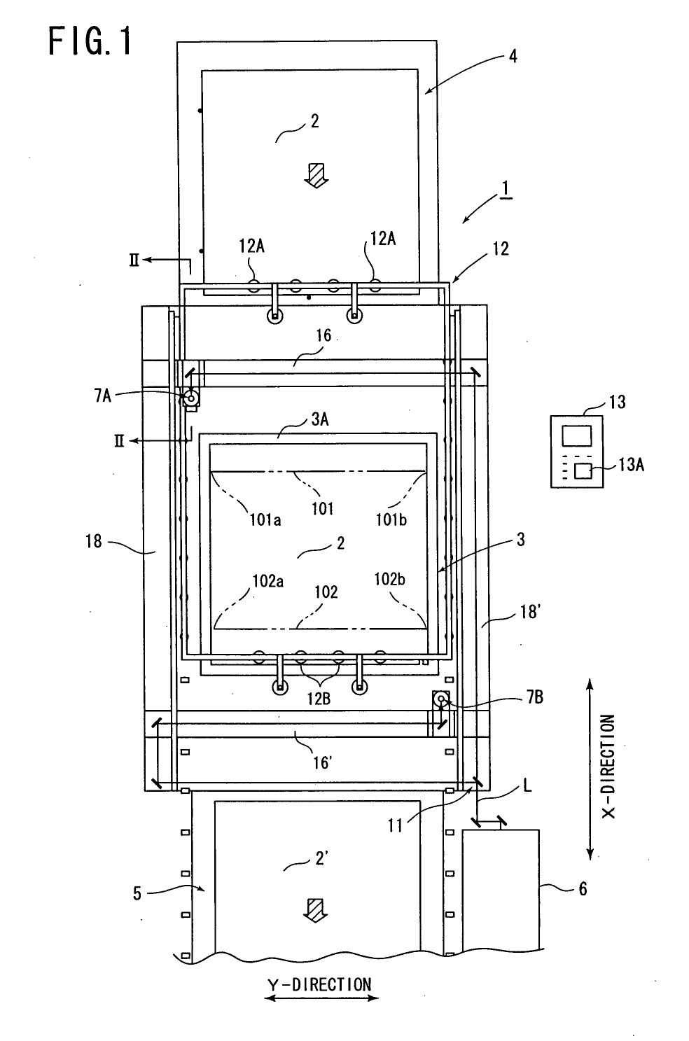

Embodiments of the present invention will be described below on the basis of the drawings. In FIG. 1, the reference numeral 1 denotes a laser dividing device. This laser dividing device 1 divides material glass 2 as a brittle material into a square having a prescribed size.

The laser dividing device 1 is provided with a working table 3 that has a horizontal and flat placement surface 3A and supports, on the placement surface 3A, material glass 2 that is beforehand formed in the shape of a square, a material table 4 that is arranged in a close position on one side of this working table 3 and supports a material glass 2, and a product table 5 that is arranged in a close position on the other side of the working table 3 and supports a glass substrate 2′ as a product conveyed from the working table 3.

On the placement surface 3A of the working table 3 there are formed a large number of pores, which are not shown in the drawing, and it is possible to cause the material glass 2 to float above the placement surface 3A by causing air to jet from these many pores as required. On the other hand, by causing negative pressure to act on the many pores after the placement of the material glass 2 on the placement surface 3A, it is possible to cause the placement surface 3A to adsorb and hold the material glass 2. In the same manner as the working table 3, on the placement surface of the material table 4 and the product table 5, there are also provided with a large number of pores that supply and discharge air, and as required the material glass 2 or a glass substrate 2′ is adsorbed on the placement surface or caused to float above the placement surface. Incidentally, pores that jets air as required are provided also between tables that provide conveyance surfaces for the material glass 2 and the product glass 2′.

The laser dividing device 1 is provided with a laser oscillator 6 that oscillates laser beam L, a first working head 7A and a second working head 7B that are moved independently of each other by a moving mechanism, which will be described later, in the X- and Y-directions of horizontal plane, and radiate laser beam L toward the material glass 2 on the working table 3, and a light guiding means 11 that divides the laser beam L oscillated by the laser oscillator 6 and guides the laser beam L to the two working heads 7A, 7B, the light guiding means 11 comprising a plurality of optical parts.

The laser dividing device 1 is provided with frame-like conveyance means 12 that has a plurality of adsorption pads 12A, 12B capable of adsorbing and holding the material glass 2 and the glass substrate 2′ after dividing, and is moved on the material table 4, the working table 3 and the product table 5 in the X-direction, and a controller 13 that controls the actions of the conveyance means 12, the laser oscillator 6 and the two working heads 7A, 7B. Incidentally, an XYZ-coordinate system based on a downward moving end of the first working head 7A of the laser dividing device 1 in FIG. 1, a rightward moving end in FIG. 1, and the placement surface 3A of the working table 3 are set and it is configured so that each part is controlled according to a working program registered in the controller 13.

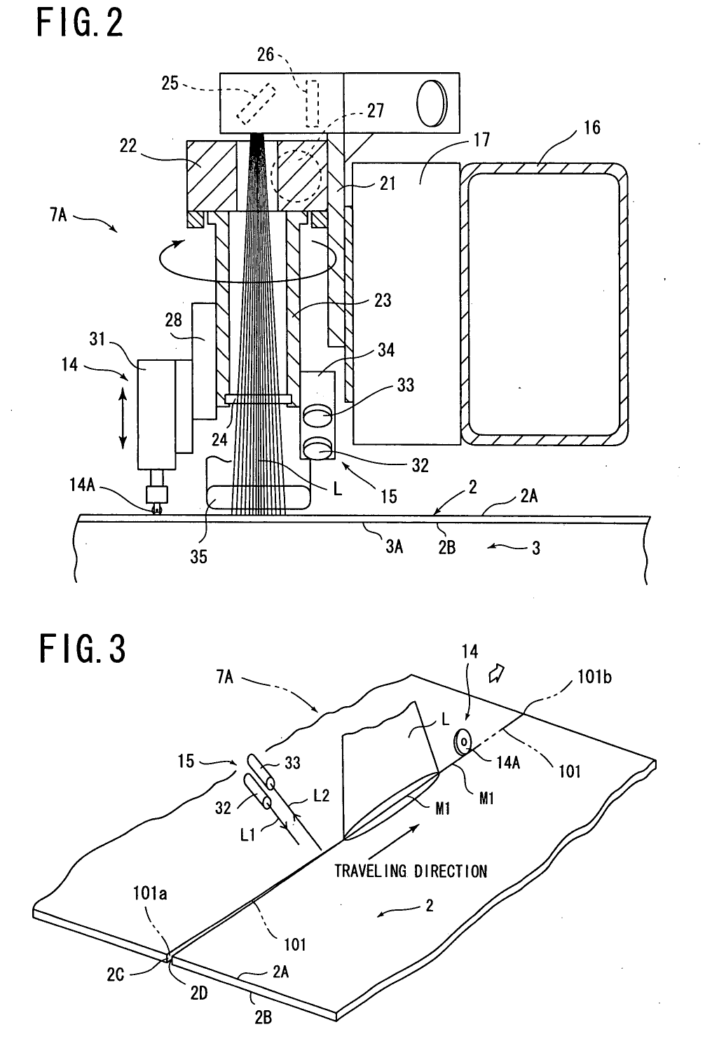

As shown in FIG. 2, the first working head 7A and the second working head 7B as the dividing mechanism are rotatably configured, and a groove forming mechanism 14 having a mechanical cutter 14A and an inspection device 15 that inspects whether or not the material glass 2 has been divided are provided on these working heads 7A, 7B.

A pair of movable guide rails 16, 16′ parallel to the Y-direction is provided on the working table 3, and each of the working heads 7A, 7B is mounted so as to be movable in the Y-direction on each of the movable guide rails 16, 16′. It is configured so that each of the working heads 7A, 7B is moved by a first moving mechanism 17, 17 along the movable guide tables 16, 16′ in the Y-direction.

Both end portions of each of the movable guide rails 16, 16′ are caused to engage with a pair of X-direction guide rails 18, 18′ arranged, with the working table 3 interposed therebetween, and it is configured so that each of the movable guide rails 16, 16′ on which the two working heads 7A, 7B are mounted is moved by an unillustrated second moving mechanism along the X-direction guide rails 18, 18′ in the X-direction. It is configured so that the first moving mechanism 17 and the second moving mechanism are brought into action by the controller 13. It is configured so that the controller 13 controls the action of the first moving mechanism 17 and the second moving mechanism, whereby each of the working heads 7A, 7B can be moved on the horizontal plane in the X- and Y-directions.

As shown in FIG. 2, the first working head 7A is provided with a bracket 21 that is caused to engage with the movable guide rail 16 so as to be movable in the Y-direction, an annular member 22 that is rotatably supported by this bracket 21, a tube member 23 whose top end portion is connected to this annular member 22 and whose axis center is maintained in a vertical direction, a cylindrical lens 24 that is attached to below an inner circumferential portion of this tube member 23, and a reflecting mirror 25 that is connected to the bracket 21 in an inclined condition above the annular member 22.

As shown in FIG. 2, on the bracket 21 of the first working head 7A, a beam homogenizer 26 is provided in a fixed manner on an optical path of laser beam L, which is the front side of the reflecting mirror 25. The laser beam L oscillated by the laser oscillator 6 passes through the beam homogenizer 26 via the light guiding means 11, whereby it is configured so that the intensity distribution of the laser beam L is formed in top-hat shape and a spread angle of approximately 5 degrees is given to the laser beam L.

The laser beam L that has passed through the beam homogenizer 26 is reflected by the reflecting mirror 25 downward in a vertical direction and passes through the cylindrical lens 24 and is then irradiated to the material glass 2. The laser beam L passes through the cylindrical lens 24, whereby it is configured so that as shown in FIG. 3, the laser beam L is formed in a sectional shape of an elongated leave of a tree in the traveling direction (working direction). Because the laser beam L that is given the shape of such an elongated leave of a tree is radiated to the material glass 2, it is configured so that the working speed can be increased compared to a case where working is performed by radiating laser beam L having a sectional shape of a circle is irradiated to the material glass 2.

As will be described in detail later, a continuous minute V-shaped groove M1 is first formed by the mechanical cutter 14A in the whole region on a straight-line division-planned line 101 set on a front surface 2A of the material glass 2 and it is configured so that the laser beam L is radiated to the minute groove M1 while the laser beam L is being caused to move following the mechanical cutter 14A. The minute groove M1 is heated due to the radiation of the laser beam L and as a result, it is configured so that a crack initiated from the bottom portion of the groove reaches a rear surface 2B, whereby the material glass 2 is divided.

The first working head 7A and the second working head 7B having the same configuration as the first working head 7A constitute a dividing mechanism that performs division by causing a crack to be propagated from the minute groove M1 formed by the groove forming mechanism 14.

The annular member 22 and the tube member 23, which are integral with each other, are interlocked with an actuator 27 provided on the upper part of the bracket 21, and it is configured so that the action of this actuator 27 is controlled by the controller 13. When the actuator 27 is brought into action by the controller 13 as required, it is configured so that the annular member 22 and the tube member 23 rotate by a required angle, with a center axis in a vertical direction serving as the center of rotation.

The groove forming mechanism 14 is attached to a side surface of a lower part of the tube member 23 via a bracket 28 and the inspection device 15 is attached in a position shifted 180 degrees circumferentially with respect to the groove forming mechanism 14. As a result of this, the mechanical cutter 14A and the inspection device 15 are positioned in lengthwise positions, with the optical path of the laser beam L passing through the position of the axis center of the tube member 23 interposed therebetween.

The actuator 27 causes the tube member 23 of the first working head 7A to rotate by a required angle, and as a result, the mechanical cutter 14A, the laser beam L and the inspection device 15 can be rotated on the horizontal plane, with the above-described positional relationship maintained.

A hoisting mechanism 31 is attached to the tube member 23 via the bracket 28, and it is configured so that the mechanical cutter 14A is caused to ascend and descend by this hoisting mechanism 31 and the action of the hoisting mechanism 31 is controlled by the controller 13.

It is configured so that when the hoisting mechanism 31 has moved the mechanical cutter 14A to a descent end in accordance with a command from the controller 13, the bottom end of the mechanical cutter 14A is positioned at a height where the bottom ends of the mechanical cutter 14A abuts against the surface 2A of the material glass 2. It is configured so that when in this state the first working head 7A has been moved by the first moving mechanism 17 or the second moving mechanism, the mechanical cutter 14A rotates, whereby a continuous minute groove M1 is formed on the front surface 2A of the material glass 2 (see FIG. 3).

It is configured so that when the hoisting mechanism 31 has moved the mechanical cutter 14A to an ascent end in accordance with a command from the controller 13, the bottom end of the mechanical cutter 14A departs from the material glass 2. It is configured so that in this state, no groove is formed in the material glass 2 by the mechanical cutter 14A.

Next, as shown in FIGS. 2 and 3, the inspection device 15 is provided with inspection light radiating means 32 that radiates inspection light L1 to an area of the material glass 2 to be divided, light receiving means 33 that receives reflected light L2 occurring when the inspection light L1 radiated from this inspection light radiating means 32 to the material glass 2 is reflected from the material glass 2, and storage means 13A that stores a divided area that has been completely divided and an undivided portion on the basis of the reflected light L2 received by the light receiving means 33, the storage means 13A being provided in the controller 13 (see FIG. 1).

The inspection light radiating means 32 and the light receiving means 33 are connected, in a vertically adjacent manner, to a bracket 34 that is connected to the bottom end of an outer circumferential portion of the tube member 23. The inspection light radiating means 32 is adapted to radiate the inspection light L1 to an area that becomes a division-planned line 101 set on the front surface 2A of the material glass 2 from the position obliquely above the area_and in a direction orthogonal to the area. Laser beam is adopted as the inspection light L1 because it has a wavelength transparent to the material glass 2 as a brittle material and intensity and straight-line travel are necessary to a certain extent. It is configured so that when the inspection light radiating means 32 has been brought into action by the controller 13, laser beam as the inspection light L1 is radiated from the inspection light radiating means 32 to the material glass 2.

The light receiving means 33 is arranged in a position immediately above the inspection light radiating means 32 in an adjacent manner. Thus, in this embodiment, the inspection light radiating means 32 and the light receiving means 33 are arranged above the surface 2A of the material glass 2 and in vertically close positions.

The light receiving means 33 comprises a photo sensor that sends out on/off signals according to the received quantity of light of the received reflected light L2, and it is configured so that signals sent out from this light receiving means 33 are transmitted to the controller 13.

The inspection device 15 configured so that the reflected light L1 from the material glass 2 is received by the light receiving means 33 based on the following principle.

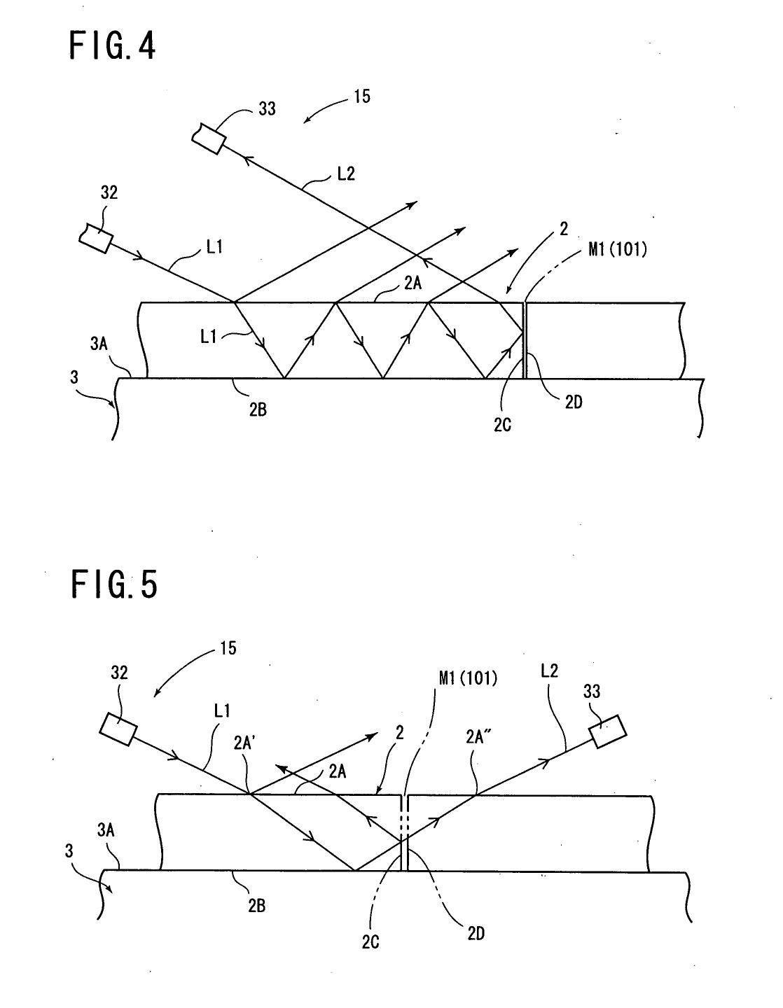

That is, in a case where the area of the division-planned line 101 irradiated with the laser beam L of the dividing mechanism has been completely divided from a groove to a rear surface portion, as shown in FIG. 4, a pair of vertical divided surfaces 2C, 2D occurs in the divided area along the division-planned line 101, divided surfaces 2C, 2D being slightly separated from each other.

When the inspection light L1 is radiated from the inspection light radiating means 32 toward the material glass 2 by following the movement of the laser beam L, the inspection light L1 enters the interior of the material glass 2 from the front surface 2A thereof and is reflected by the rear surface 2B of the interior (see FIG. 4). It is configured so that after that, the inspection light L1 is reflected alternately by the front surface 2A of the interior of the material glass 2 and the rear surface 2B of the interior and reflected by the divided surface 2C, thereafter passes through the front surface 2A of the material glass 2 as the reflected light L2, leaves the material glass 2 to outside, and is received by the light receiving means 33.

Thus, it is configured so that the material glass 2 is divided exactly according to the division-planned line 101 and that when a pair of divided surfaces 2C, 2D occurs, the reflected light L2 occurring by the reflection by the divided surface 2C is received by the light receiving means 33.

In other words, the light receiving means 33 is arranged in a position where the reflected light L2 from the divided surface 2C can be obtained, the position being above the inspection light radiating means 32 in a close proximity thereto.

On the other hand, when the area of the division-planned line 101 has not been divided, the above-described pair of divided surfaces 2C, 2D does not occur in the area of the division-planned line 101 on the material glass 2. That is, in this case, even when the inspection light L1 is radiated from the inspection light radiating means 32 to the material glass 2, the reflected light L2 that is reflected by a divided surface of the material glass 2 is not received by the light receiving means 33.

As schematically shown in FIG. 3, it is configured so that the laser beam L is radiated to the area of the groove M1 formed by the mechanical cutter 14A while the working head 7A is being moved along the division-planned line 101 of the material glass 2 and that the inspection light L1 is radiated from the inspection light radiating means 32 to the material glass 2 by following the laser beam L. It is configured so that on that occasion, whether or not the reflected light L2 from the material glass 2 is present is constantly transmitted to the controller 13 as a signal by the light receiving means 33, and the controller 13 configured so that when a signal indicating the presence of the reflected light L2 has changed to a signal indicating the absence of the reflected light L2, the position where the division-planned line and the inspection light intersect each other at the timing of the change, i.e., an XY-coordinate value of the position of a leading end that becomes an undivided portion is stored in the storage means 13A. As a result of this, it is configured so that the divided portion and undivided portion of the division-planned line 101 can be recognized.

As will be described later, on the basis of the data stored in the storage means 13A, the controller 13 radiates the laser beam L again to a portion where the reflected light L2 has not been obtained, i.e., an undivided portion, whereby it is configured so that the whole region of the division-planned line 101 of the material glass 2 can be completely divided.

Incidentally, the arrangement of the inspection light radiating means 32 and the light receiving means 33 in the inspection device 15 may be reversed. Thus, in the inspection device 15, the light receiving means 33 is constituted by an inexpensive photo sensor without the provision of an expensive camera or image processing device.

At the outer circumference of a bottom end portion of the tube member 23 in the first working head 7A, a nozzle 35 for air injection and suction is arranged, with the optical path of the laser beam L interposed. When the material glass 2 is divided, it is configured so that the air is sucked in by use of the nozzle 35 and that cullets occurring in divided portions are sucked and recovered by the nozzle 35. This configured so that cullets are prevented from scattering to the surroundings of worked portions.

The second working head 7B is configured in the same manner as the first working head 7A described above, and it is configured so that the controller 13 controls the action of the two working heads 7A, 7B independently of each other.

In the above-described configuration, the division of the material glass 2 by the laser dividing device 1 is performed as described below.

That is, when a sheet of rectangular material glass 2 is supplied to a prescribed position on the material table 4, the conveyance means 12 is moved onto the material table 4 and a portion of a top surface of the material glass 2 on the working table 3 side is adsorbed and held by the adsorption pad 12A on the one-end side in the X-direction in the frame of the conveyance means 12.

After that, air is jetted from the plurality of pores to the material table 4 and the placement surface 3A of the working table 3 and to between the two tables, and the material glass 2 on the material table 4 is caused to float by the air. In this state, the conveyance means 12 holding the material glass 2 is moved in the X-direction, whereby the material glass 2 held by the conveyance means 12 is conveyed to a prescribed position on the working table 3. After that, the air jetting on the material table 4 and the placement surface of the working table 3 and between the two tables is stopped, the holding state of the material glass 2 by the conveyance means 12 is released and negative pressure is introduced into the pores of the placement surface 3A of the working table 3. Therefore, the material glass 2 is adsorbed and held by this negative pressure onto the placement surface 3A.

By bringing the first moving mechanism 17, the second moving mechanism and the actuator 27 into action, the controller 13 causes the first working head 7A to face the traveling direction, causes the mechanical cutter 14A to position outward on an extension line of an end 101a of a division-planned line 101 of the material glass 2, with the mechanical cutter 14A moving ahead, and causes the hoisting mechanism 31 to lower the mechanical cutter 14A of the groove forming mechanism 14 to the descent end. Similarly, the controller 13 positions the second working head 7B outward on an extension line of an end 102a of a division-planned line 102 of the material glass 2, with the mechanical cutter 14A moving ahead, and causes the hoisting mechanism 31 to lower the mechanical cutter 14A of the second working head 7B to the descent end.

In this state, the controller 13 moves the two working heads 7A, 7B toward the division-planned lines 101, 102 via the first moving mechanism 17 and the second moving mechanism and then moves the two working heads 7A, 7B along the division-planned lines 101, 102 at a prescribed speed. Just after start of the movement of the two working heads 7A, 7B, the controller 13 brings the laser oscillator 6 into action, causes laser beam L to be oscillated, and causes inspection light L1 to be radiated from the inspection light radiating means 32 of the two working heads 7A, 7B toward the material glass 2 (see FIGS. 1 to 3).

Thus, as a result of the movement of the two working heads 7A, 7B, the mechanical cutter 14A of the two working heads 7A, 7B abuts against one end 101a, 102a of the division-planned lines 101, 102, from there to the other end 101b, 102b is formed a minute groove M1 on the surface of the material glass 2, the laser beam L is radiated to the groove M1 thus formed while being moved. So as to follow the movement of the laser beam L, the inspection light L1 is continuously radiated from the inspection light radiating means 32 toward an area of the material glass 2 to be divided, to which the laser beam L has been radiated, and whether or not the reflected light L2 from the material glass 2 is present is transmitted as a signal by the light receiving means 33 to the controller 13.

As described above, when a crack caused to be propagated from a minute continuous groove M1 formed in the material glass 2 and the material glass 2 is completely divided, as shown in FIG. 4, the divided surfaces 2C, 2D occur in the areas of the division-planned lines 101, 102 of the material glass 2 and the reflected light L2 reflected by the divided surface 2C near the inspection device 15 is detected by the light receiving means 33. On the other hand, when an undivided portion where the material glass 2 is not completely divided occurs, the divided surfaces 2C, 2D are not formed and, therefore, it is impossible to obtain the reflected light L2 by the light receiving means 33. The two working heads 7A, 7B are once moved by the controller 13 from one end 101a, 102a of the division-planned lines 101, 102 to a position beyond the other end 101b, 102b, a minute continuous groove M1 is formed in the whole region of the two division-planned lines 101, 102, and in this process the laser beam L is radiated to the minute groove M1 in order to heat the material glass 2, whereby division is performed. At the time when the detection of the reflected light L2 by the light receiving means 33 of the inspection device 15 is interrupted, that is, when an undivided portion occurs, the controller 13 stops the oscillation of the laser beam L by the laser oscillator 6 and stores the XYZ-coordinate value of the position where the reflected light L2 has not been obtained in the storage means 13A.

After that, when an undivided portion has occurred, on the basis of the stored contents of the storage means 13A, the controller 13 causes the hoisting mechanism 31 to ascend the groove forming mechanism 14 and causes the first moving mechanism 17 and the second moving mechanism to move the two working heads 7A, 7B backward along the division-planned lines 101, 102 to the undivided portion where the reflected light L2 has not been obtained, with the mechanical cutter 14A kept separated from the material glass 2.

After that, the controller 13 moves the two working heads 7A, 7B again from the undivided portion along the division-planned lines 101, 102, and causes the laser oscillator 6 to oscillate the laser beam L again, whereby the region from the undivided portion to the other end is irradiated with the laser beam L. Also on that occasion, the controller 13 causes the inspection device 15 to radiate the inspection light L1 to the material glass 2 and to inspect the occurrence of an undivided portion by detecting the presence or absence of the reflected light L2.

That is, with the mechanical cutter 14A separated from the material glass 2 and maintained above, while the two working heads 7A, 7B are being moved along the division-planned lines 101, 102, the laser beam L is radiated again to the undivided portion in the groove M1 that has already been formed, whereby the material glass 2 is completely divided by causing a crack to be propagated from the groove M1 formed in the undivided portion.

In this manner, the laser dividing device 1 divides the material glass 2 exactly according to the division-planned lines 101, 102 by use of the two working heads 7A, 7B.

When the material glass 2 is further divided along unillustrated division-planned lines in the X-direction, the controller 13 rotates the two working heads 7A, 7B 90 degrees via the actuator 27 and causes the first moving mechanism 17 and the second moving mechanism to move each of the working heads 7A, 7B to a required position.

After that, in the same manner as the case where the area along the two division-planned lines 101, 102 have been divided, the controller 13 controls the action of each of the component members and divides the areas of the unillustrated division-planned lines in the X-direction by use of each of the working heads 7A, 7B.

When the division of the material glass 2 by the laser dividing device 1 has been finished like this, the introduction of negative pressure into the pores of the placement surface 3A of the working table 3 is stopped and remaining materials cut off from the material glass 2 are removed from the working table 3 by use of an unillustrated removal device.

After that, the air is jetted from the above-described many pores on to all of the tables and between the tables, and a glass substrate 2′ as a product is caused to float above the placement surface 3A of the working table 3.

At the same time as this, also the material glass 2 that has already been supplied to the material table 4 is caused to float by the air supplied to the placement surface of the material table 4. The material glass 2 is adsorbed and held by the adsorption pad 12A on the one-end side in the X-direction in the conveyance means 12, and simultaneously the glass substrate 2′ on the working table 3 is adsorbed and held by the adsorption pad 12B on the other-side end in the X-direction in the conveyance means 12.

After that, because the conveyance means 12 is moved parallel toward the product table 5 in the X-direction, new material glass 2 is supplied on the working table 3 and the glass substrate 2′ as a product is conveyed onto the product table 5 (see FIG. 1).

After that, the air jetting in each part is stopped and the holding state of the material glass 2 and the glass substrate 2′ by the conveyance means 12 by use of the adsorption pads 12A, 12B is canceled. It is configured so that negative pressure is introduced into the pores of the placement surfaces of the working table 3 and the product table 5, whereby the new material glass 2 and the glass substrate 2′ are adsorbed and held by each table.

As described above, in this embodiment, the first working head 7A is moved to form a minute groove M1 in the division-planned line 101 from one end 101a of the division-planned line 101 to the other end 101b thereof by use of the mechanical cutter 14A, division is performed by irradiating the minute groove M1 with laser beam L, and in this process a divided portion and an undivided portion are inspected by the inspection device 15, whereby it is configured so that the position of the undivided portion is stored by the storage means 13A. After that, the first working head 7A is moved backward, with the mechanical cutter 14A held above, and the first working head 7A is then moved in the moving direction, with the mechanical cutter 14A maintained above, whereby it is configured so that the laser beam L is radiated to the groove M1 that has been formed beforehand.

For this reason, a minute groove M1 is not formed double in the undivided portion and there is only the single minute groove M1 formed beforehand. A crack caused to be propagated due to the laser beam L, with this groove M1 serving as an initiation point, and the material glass 2 is completely divided.

For this reason, according to the working method by use of the laser dividing device 1 of this embodiment, it is possible to divide the material glass 2 exactly according to the division-planned line 101 (102), and no defective product will occur.

Each of the working heads 7A, 7B is provided with the groove forming mechanism 14, the dividing mechanism and the inspection device 15, and the inspection light radiating means 32 and light receiving means 33 of the inspection device 15 are arranged in close proximity to each other. Furthermore, the groove forming mechanism 14, the dividing mechanism and the inspection device 15 are integrally provided so as to be rotatable by use of the actuator 27.

This configuration enables the size of the inspection device 15 to be reduced and eventually enables the whole laser dividing device 1 to be miniaturized.

According to the above-described inspection device 15 which irradiates inspection light to a divided surface from orthogonal directions and receives reflected light from the orthogonal directions, it is possible to accurately detect a divided portion and an undivided portion even in a case where two division-planned lines of the material glass 2 are orthogonal in the X- and Y-directions. In this case, the division-planned line in either of the X- and Y-directions is divided first and then the other division-planned line is divided. Even in such as case, however, according to the above-described inspection device 15, it is possible to accurately detect a divided portion and an undivided portion of the material glass 2.

Next, FIG. 5 shows another embodiment relating to an inspection device 15 which is provided on each of the working heads 7A, 7B. That is, in the first embodiment described above, with attention paid to the fact that the divided surfaces 2C, 2D appear when the material glass 2 is completely divided, it is configured so that the reflected light L2 from the divided surface 2C is received by the light receiving means 33. In this second embodiment, however, the arrangement position of the light receiving means 33 is changed as follows. That is, the light receiving means 33 is arranged on the front surface 2A side of the material glass 2, which becomes a side opposite to the inspection light radiating means 32, interposing the divided surfaces 2C, 2D that will be formed in the division-planned line 101 of the material glass 2. In this case, when inspection light L1 is radiated from the inspection light radiating means 32 toward the material glass 2, the inspection light L1 enters the interior of the material glass 2 from the front surface 2A thereof and then is reflected by the rear surface 2B of the interior. After that, the inspection light L1 passes through the front surface 2A of the interior, goes to outside the material glass 2, and is received as the reflected light L2 by the light receiving means 33.

That is, it follows that the area to be divided lies between the position 2A′ where the inspection light L1 enters from the front surface 2A side of the material glass 2 thereof and the position 2A″ where the reflected light L2 leaves the material glass 2 to outside after passing through the front surface 2A. For this reason, when the material glass 2 is completely divided, in this case, the divided surfaces 2C, 2D occur between the two positions 2A′ and 2A″. In this case, therefore, part of the reflected light L2 is reflected by the divided surface 2C. For this reason, the intensity of the reflected light L2 received by the light receiving means 33 becomes weak. On the other hand, when the divided surfaces 2C, 2D do not occur, the intensity of the reflected light L2 received by the light receiving means 33 becomes strong. It is configured so that whether or not the material glass 2 has been divided is inspected by such a difference in the intensity of the reflected light L2.

Other components other than the inspection device 15 are the same as in the first embodiment. The same operation and effect as in the first embodiment can be obtained also in the second embodiment of this configuration.

Incidentally, it is possible to adopt the following working steps as the working steps of the material glass 2 by use of the laser dividing device 1. That is, as described above, it is possible to adopt the method which is such that the two working heads 7A, 7B are moved along the division-planned lines 101, 102, and by use of the inspection device 15 the presence of an undivided portion in the area of the division-planned line 101 to be divided is detected while a groove M1 is being formed from one end of the division-planned line to the other end thereof, and it is also possible to adopt a method which is such that the radiation of the laser beam L from each of the working heads 7A, 7B is continued and a groove M1 is formed by each of the mechanical cutters 14A to a terminal end of the division-planned lines 101, 102.

After that, as described above, the two working heads 7A, 7B are moved backward to an undivided portion and then the laser beam L is radiated to the undivided portion again, whereby the material glass 2 is completely divided. Even with such working steps, it is possible to obtain the same operation and effect as in the above-described embodiments.

The formation of a minute groove by the groove forming mechanism and the propagation of a crack by the dividing mechanism by use of laser beam may be separately performed.

In the above-described embodiments, the mechanical cutter 14A is used as the groove forming mechanism 14 that forms a minute groove M1. However, the groove forming mechanism 14 that uses laser beam may be adopted in place of the mechanical cutter 14A, and it is possible to form a minute continuous groove on the front surface 2A or the rear surface 2B by radiating laser beam to the material glass 2 from the groove forming mechanism 14 before the heating by laser beam L from the two working heads 7A, 7B.

Furthermore, a projecting/receiving sensor may also be used as the inspection device 15 in the above-described embodiments.

1. A method for dividing a brittle material comprising a working head that is moved relatively with respect to a brittle material, a groove forming mechanism that is provided on the working head and forms a minute continuous groove in the brittle material along a division-planned line of the brittle material, a dividing mechanism that is provided on the working head and causes a crack to be propagated from the minute groove by irradiating the brittle material with laser beam while being moved following the groove forming mechanism, an inspection means that is provided on the working head and inspects whether or not the place of the division-planned line has been divided, and storage means that stores the position of an undivided portion detected by the inspection means, the working head is moved from one end of the division-planned line to the other end thereof with respect to the brittle material, whereby a continuous minute groove is formed by the groove forming mechanism along the division-planned line, thereafter division is performed by causing a crack to be propagated from the minute groove by use of the dividing mechanism, a divided portion is detected by the inspection device, whereas the position of the undivided portion detected by the inspection means is stored by use of the storage means, and when an undivided portion has been detected, the working head is moved along the undivided portion and the brittle material is divided exactly according to the division-planned line by irradiating the brittle material with laser beam by use of the dividing mechanism without the formation of a groove by the groove forming mechanism.

2. The method for dividing a brittle material according to claim 1, characterized in that the inspection means comprises inspection light radiating means that radiates inspection light toward the brittle material and light receiving means that receives reflected light occurring when the inspection light radiated from the inspection light radiating means is reflected by a divided surface of the brittle material, and in that the inspection light radiating means and the light receiving means are arranged on a front surface side of the brittle material to be worked to detect an undivided portion.

3. An apparatus for dividing a brittle material comprising a groove forming mechanism that forms a minute continuous groove in the brittle material along a division-planned line of the brittle material and a dividing mechanism that causes a crack to be propagated from the minute groove by irradiating the brittle material with laser beam while being moved following the groove forming mechanism, characterized in that the apparatus further comprises an inspection device that inspects whether or not the place of the division-planned line has been divided, the inspection device comprising inspection light radiating means that radiates inspection light toward the brittle material and light receiving means that receives reflected light occurring when the inspection light radiated from the inspection light radiating means to the brittle material is reflected by a divided surface of the brittle material, and in that the inspection light radiating means and the light receiving means are arranged so as to move relatively parallel to the divided surface on a front surface side of the brittle material.

4. An apparatus for dividing a brittle material comprising a groove forming mechanism that forms a minute continuous groove in the brittle material along a division-planned line of the brittle material and a dividing mechanism that causes a crack to be propagated from the minute groove by irradiating the brittle material with laser beam while being moved following the groove forming mechanism, characterized in that the apparatus further comprises an inspection device that inspects whether or not the place of the division-planned line has been divided, the inspection device comprising inspection light radiating means that radiates inspection light toward the brittle material and light receiving means that receives reflected light occurring when the inspection light radiated from the inspection light radiating means to the brittle material is reflected by a rear surface of the interior of the brittle material, in that the inspection light radiating means and the light receiving means are arranged so as to be able to move relatively parallel to the divided surface on a front surface side of the brittle material, and in that inspection device judges that a divided surface has been formed when the light receiving means cannot receive reflected light even inspection light is radiated from the inspection light radiating means to the brittle material.

5. The apparatus for dividing a brittle material according to claim 3, characterized in that a working head capable of moving relatively with respect to the brittle material is provided with the groove forming mechanism and the dividing mechanism, in that the apparatus comprises a moving mechanism that moves the working head and further comprises control means that controls the action of the moving mechanism and has storage means that stores the position of an undivided portion detected by the inspection device, in that the working head is moved from one end of the division-planned line to the other end thereof with respect to the brittle material, whereby a continuous minute groove is formed along the division-planned line, thereafter division is performed by causing a crack to be propagated from the minute groove by use of the dividing mechanism, a divided portion is detected by the inspection device, whereas the position of the undivided portion detected by the inspection device is stored by use of the storage means, and in that when an undivided portion has been detected by the inspection device, the working head is moved along the undivided portion and the brittle material is divided exactly according to the division-planned line by irradiating the brittle material with laser beam by use of the dividing mechanism without the formation of a groove by the groove forming mechanism.
